(19) United States
(12) Patent Application Publication
(10) Pub. No.: US 2023/0342873 A1
(43) Pub. Date: Oct. 26, 2023

(54) ASSISTANCE DEVICE, SYSTEM, ASSISTANCE METHOD, AND NON-TRANSITORY COMPUTER-READABLE MEDIUM

(71) Applicant: NEC Corporation, Minato-ku, Tokyo (JP)

(72) Inventor: Masahiro TANI, Tokyo (JP)

(73) Assignee: NEC Corporation, Minato-ku, Tokyo (JP)

(21) Appl. No.: 18/030,227

(22) PCT Filed: Oct. 9, 2020
(86) PCT No.: PCT/JP2020/038229

§ 371 Date: Apr. 4, 2023

(51) Int. Cl. G06Q 50/26; G06F 21/32

(52) U.S. Cl. CPC G06Q 50/265; G06F 21/32

(57) ABSTRACT

An assistance device (10) includes a personal information extraction unit (11) that extracts personal information being capable of discriminating a target user holding a target account, based on account information to be acquired from the target account in cyberspace, a position information extraction unit (12) that extracts position information related to the target user, based on the account information, and an output unit (13) that outputs the extracted personal information and the extracted position information as assistance information for assisting crime prevention around the position information in physical space.

### TECHNICAL FIELD

The present invention relates to an assistance device, a system, an assistance method, and a non-transitory computer-readable medium.

### BACKGROUND ART

In recent years, an Internet service such as social media has become popular and widely used throughout the world. Meanwhile, because of convenience and high anonymity, the number of crimes using cyberspace has been increased, and it is desired to prevent such a crime in advance. As a related technique, for example, Patent Literature 1 is known. Patent Literature 1 describes that, in gate equipment of a public facility, safety from a crime is ensured by collating a person passing through a gate with a person in a suspicious person list.

### CITATION LIST

### Patent Literature

[Patent Literature 1] Japanese Unexamined Patent Application Publication No.2017-167931

### SUMMARY OF INVENTION

### Technical Problem

According to a related technique such as Patent Literature 1, it is possible to monitor a suspicious person in physical space (real space) by using a suspicious person list prepared in advance. However, the related technique does not consider a crime using cyberspace, and it is difficult to efficiently perform monitoring or investigation in the physical space by using information in the cyberspace.

In view of such a problem, an object of the present disclosure is to provide an assistance device, a system, an assistance method, and a non-transitory computer-readable medium that are capable of efficiently performing monitoring or investigation.

### Solution to Problem

An assistance device according to the present disclosure includes: a personal information extraction means for extracting personal information being capable of discriminating a target user holding a target account, based on account information to be acquired from the target account in cyberspace; a position information extraction means for extracting position information related to the target user, based on the account information; and an output means for outputting the extracted personal information and the extracted position information as assistance information for assisting crime prevention around the position information in physical space.

A system according to the present disclosure includes: a plurality of monitoring systems configured to monitor different locations; and an assistance device, wherein the assistance device includes: a personal information extraction means for extracting personal information being capable of discriminating a target user holding a target account, based on account information to be acquired from the target account in cyberspace; a position information extraction means for extracting position information related to the target user, based on the account information; and an output means for outputting the extracted personal information to the monitoring system to be selected based on the extracted position information.

An assistance method according to the present disclosure includes: extracting personal information being capable of discriminating a target user holding a target account, based on account information to be acquired from the target account in cyberspace; extracting position information related to the target user, based on the account information; and outputting the extracted personal information and the extracted position information as assistance information for assisting crime prevention around the position information in physical space.

A non-transitory computer-readable medium according to the present disclosure stores an assistance program for causing a computer to execute processing of: extracting personal information being capable of discriminating a target user holding a target account, based on account information to be acquired from the target account in cyberspace; extracting position information related to the target user, based on the account information; and outputting the extracted personal information and the extracted position information as assistance information for assisting crime prevention around the position information in physical space.

### Advantageous Effects of Invention

According to the present disclosure, it is possible to provide an assistance device, a system, an assistance method, and a non-transitory computer-readable medium that are capable of efficiently performing monitoring or investigation.

### BRIEF DESCRIPTION OF DRAWINGS

FIG. 1 is a configuration diagram illustrating an outline of an assistance device according to an example embodiment;

FIG. 2 is a configuration diagram illustrating a configuration example of a cyber-physical integrated monitoring system according to a first example embodiment;

FIG. 3 is a configuration diagram illustrating a configuration example of a monitoring assistance device according to the first example embodiment;

FIG. 4 is a configuration diagram illustrating a configuration example of a monitoring system according to the first example embodiment;

FIG. 5 is a flowchart illustrating an operation example of the monitoring assistance device according to the first example embodiment;

FIG. 6 is a flowchart illustrating an operation example of alternative account specification processing according to a second example embodiment;

FIG. 7 is a flowchart illustrating an operation example of alternative account specification processing according to a third example embodiment;

FIG. 8 is a flowchart illustrating an operation example of account information aggregation processing according to a fourth example embodiment;

FIG. 9 is a configuration diagram illustrating a configuration example of an image position specification unit according to a fifth example embodiment;

FIG. 10 is a configuration diagram illustrating a configuration example of a discriminator according to the fifth example embodiment;

FIG. 11 is a flowchart illustrating an operation example of training processing according to the fifth example embodiment;

FIG. 12 is a flowchart illustrating an operation example of activity area estimation processing according to a sixth example embodiment;

FIG. 13 is a flowchart illustrating an operation example of activity area estimation processing according to a seventh example embodiment; and

FIG. 14 is a configuration diagram illustrating an outline of hardware of a computer according to the example embodiment.

### EXAMPLE EMBODIMENT

Hereinafter, example embodiments will be described with reference to the drawings. In each of the drawings, a similar element is denoted by a similar reference sign, and redundant description is omitted as necessary.

### Consideration to Example Embodiment

In recent years, due to convenience and high anonymity of the Internet and social media, a center of various crimes (planning, preparation, and the like) have been shifted to cyberspace. For example, it is said that 90% of terrorism or 70% of drug trading uses the social media.

As a method for preventing such a crime, a method for registering a face photograph of a target person in a watchlist and detecting the registered person by a video of a monitoring camera is conceivable. However, because of complexity of various crime methods, it is difficult to prevent an offense in simple video monitoring based on watchlist collation. For example, it is difficult to prevent a crime such as homegrown terrorism that sympathizes with radical thoughts through the Internet and the like. In particular, it is not possible to detect a person such as a first offender without a face photograph registered in advance.

In addition, a method of detecting a suspicious behavior (wandering, deserting a baggage, or the like) from a monitoring camera video by a video behavior analysis without using a watchlist is also conceivable. However, in this method, it is difficult to define suspicious behavior, and in practice, there is possibility that a large number of pieces of behavior being unrelated to an offense are erroneously detected, and thus it is difficult to prevent the offense.

Therefore, in the following example embodiments, by integrating and using information in cyberspace and information in physical space, it is possible to specify a target person before a crime (such as an offense advance notice) on the cyberspace is transferred to the physical space, and to prevent occurrence and expansion of damage.

### Outline of Example Embodiment\

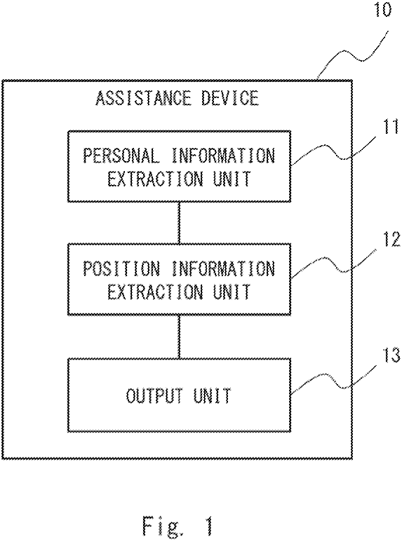

FIG. 1 illustrates an outline of an assistance device according to an example embodiment. An assistance device 10 according to the example embodiment is applicable to, for example, investigation and guard assistance for a law enforcement agency, monitoring assistance of an important facility, and the like. As illustrated in FIG. 1, the assistance device 10 includes a personal information extraction unit 11, a position information extraction unit 12, and an output unit 13.

The personal information extraction unit 11 extracts personal information being capable of discriminating a target user (also referred to as a target person) holding a target account, based on account information to be acquired from the target account in cyberspace. The position information extraction unit 12 extracts position information related to the target user, based on the account information acquired from the target account. The account information acquired from the target account may include account information of the target account and account information of a related account being related to the target account.

The output unit 13 outputs the personal information extracted by the personal information extraction unit 11 and the position information extracted by the position information extraction unit 12 as assistance information for assisting crime prevention around the position information in physical space. For example, the assistance information may be information for assisting monitoring or investigation of the target user. When monitoring assistance is performed, the output unit 13 may output the extracted personal information, as information of a person to be monitored, to a monitoring system to be selected based on the extracted position information. In addition, when investigation assistance is performed, the output unit 13 may output the extracted personal information, as information of a person to be investigated, to an investigation agency that investigates around the extracted position information.

As described above, in the example embodiment, personal information and position information of a target user holding a target account is extracted based on account information related to the target account, these pieces of information are output, and thereby crime prevention in physical space is assisted. As a result, it is possible to efficiently perform monitoring or investigation of a person of specified personal information around a position being specified based on information in cyberspace, and to effectively prevent a crime using the cyberspace.

### First Example Embodiment

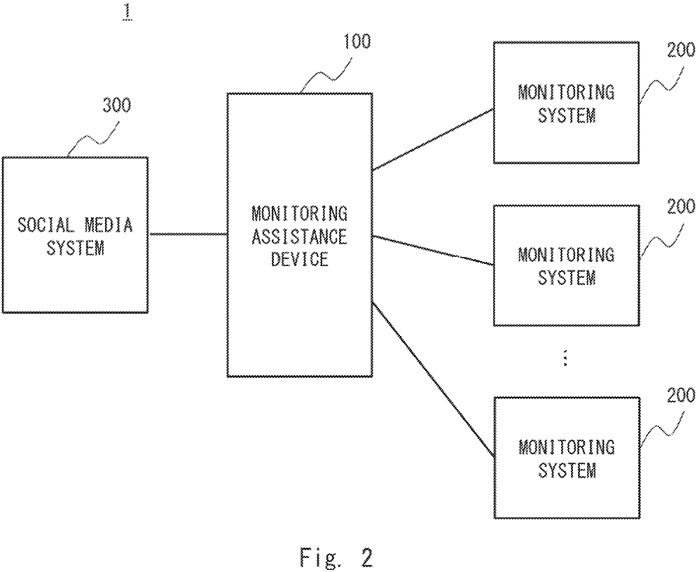

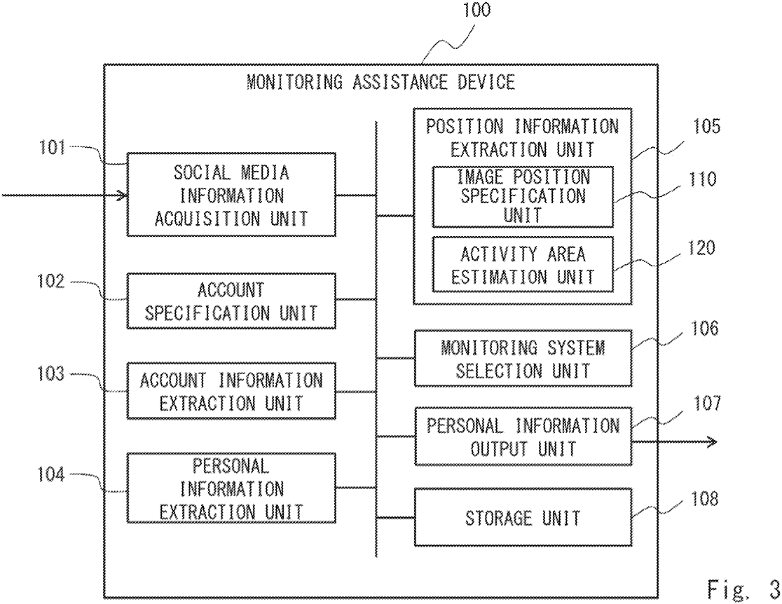

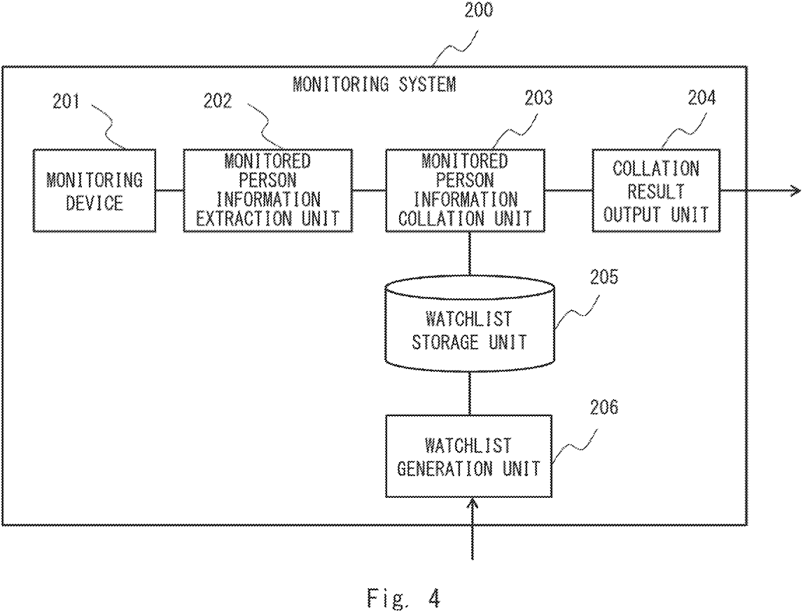

Hereinafter, a first example embodiment will be described with reference to the drawings. FIG. 2 illustrates a configuration example of a cyber-physical integrated monitoring system according to the present example embodiment, FIG. 3 illustrates a configuration example of a monitoring assistance device in FIG. 2, and FIG. 4 illustrates a configuration example of a monitoring system in FIG. 2. Note that, a configuration of each device is one example, and another configuration may be used as long as an operation (method) described later is possible. For example, a part of the monitoring system may be included in the monitoring assistance device, or a part of the monitoring assistance device may be included in the monitoring system.

A cyber-physical integrated monitoring system 1 is a system that monitors a target person in physical space, based on information of a target account in cyberspace. In the present example embodiment, personal information of the target person holding the target account and position information of the target person is acquired from account information such as posted information related to the target account on the cyberspace, and the personal information of the target person is registered in a watchlist of a monitoring system provided around the acquired position information. Note that, personal information and position information (assistance information) of a target person may be provided to a system (agency) for, not limited to monitoring the target person, investigating the target person or other crime prevention.

As illustrated in FIG. 2, the cyber-physical integrated monitoring system 1 includes a monitoring assistance device 100, a plurality of monitoring systems 200, and a social media system 300. The monitoring assistance device 100 and the plurality of monitoring systems 200, and the monitoring assistance device 100 and the social media system 300 are communicably connected with each other via the Internet or the like.

The social media system 300 is a system that provides a social media service (cyber service) such as a social networking service (SNS) on the cyberspace. The social media system 300 may include a plurality of social media services. The social media service is an online service being capable of transmitting (publishing) and communicating information between a plurality of accounts (users) over the Internet (online). The social media service is not limited to the SNS, and includes a messaging service such as a chat, a blog and an electronic bulletin board (forum site), a video sharing site and an information sharing site, a social game and a social bookmark, and the like. For example, the social media system 300 includes a server on a cloud and a user terminal. The user terminal logs in, with a user’s account, via an application programming interface (API) provided by the server, inputs or browses a timeline post, a chat conversation, and the like, and registers a connection of an account such as a friend relationship or a follow-up relationship.

The monitoring assistance device 100 is a device that assists monitoring of the monitoring system 200, based on information of the social media system 300. As illustrated in FIG. 3, the monitoring assistance device 100 includes a social media information acquisition unit 101, an account specification unit 102, an account information extraction unit 103, a personal information extraction unit 104, a position information extraction unit 105, a monitoring system selection unit 106, a personal information output unit 107, and a storage unit 108.

The storage unit 108 stores information (data) necessary for an operation (processing) of the monitoring assistance device 100. The storage unit 108 is, for example, a nonvolatile memory such as a flash memory or a hard disk device. The storage unit 108 stores a monitoring system list in which a plurality of monitoring systems 200 (monitoring devices) and a monitoring area (monitoring position) thereof are associated with each other.

The social media information acquisition unit 101 acquires (collects) social media information from the social media system 300. The social media information is account information published for each account of the social media. The account information includes profile information and posted information (a posted image, a posted moving image, a posted sentence, a posted voice, and the like) of the account.

The social media information acquisition unit 101 acquires all pieces of the social media information that can be acquired from the social media system 300. The social media information acquisition unit 101 may acquire social media information of a plurality of social media. The social media information acquisition unit 101 may acquire, from a server that provides a social media service, via an API (acquisition tool), or may acquire from a database in which social media information is stored in advance.

The account specification unit 102 specifies an account for extracting personal information and position information. The account specification unit 102 specifies a target account to be monitored (an account for extracting information of a target person), and also specifies a related account being related to the target account. The related account is an account having a connection with the target account in the social media service in the cyberspace. The related account includes a friend account in which a friend relationship is registered, and includes an account having a connection of a follow-up relationship (following-up or follower), a connection by a post (a comment to a post, a citation of a retweet or the like, a response such as “like”), a connection by a conversation (a conversation in the same community), a connection by a history (footstep) of browsing account information including a profile and posted information of each account, and the like. In addition, the account specification unit 102 specifies, as a related account, an alternative account different from the target account held by the same user as the target account by account collation processing. In other words, the account specification unit 102 is a target account specification unit that specifies a target account, and is also an alternative account specification unit (related account specification unit) that specifies an alternative account (related account). For example, the alternative account specification unit specifies an alternative account, based on account information of the target account and account information of the related account.

The account information extraction unit 103 extracts account information related to a target account from the social media information collected by the social media information acquisition unit 101. The account information extraction unit 103 extracts account information of the specified target account as account information related to the target account, and also extracts account information of the specified related account (a friend account or an alternative account).

The personal information extraction unit 104 extracts personal information of a target user (target person), based on the extracted account information related to the target account. The personal information extraction unit 104 extracts personal information of the target user holding the target account from profile information, posted information, or the like included in the account information, by using a text analysis, an image analysis technique, a voice analysis technique, and the like. The personal information is information being capable of discriminating the target user in the physical space. The personal information is, for example, biological information such as a face image, fingerprint information, and voiceprint information, but the personal information is not limited thereto, and may include soft biometric information such as a tattoo, belongings, a name (account name, discrimination ID, and the like), and attribute information such as age and gender. The personal information is preferably information used to discriminate a person in the monitoring system 200 (monitoring or investigation in the physical space), but may include other information.

The position information extraction unit 105 extracts position information of a target user, based on the extracted account information related to the target account. The position information to be extracted includes an activity base such as a place of residence (residential area) extracted from the account information, a posted location where the posted information is posted, information (global positioning system (GPS) information, a location name, a landmark in an image, and the like) that can be extracted from the posted information, and an activity area (behavior range) of the target user estimated from the information. Note that, the position information to be extracted is not limited to a current position or an ordinary activity area of the target user, and may be a location referred to in a posted sentence (a location of an offense advance notice). The location referred to in the posted sentence is extracted by, for example, natural language processing of the posted sentence. In this example, the position information extraction unit 105 includes an image position specification unit 110 and an activity area estimation unit 120. The image position specification unit 110 specifies a visit location (posted location) of the target user from projection in a posted image, or the like. The activity area estimation unit 120 estimates an activity area of the target user, based on a location specified from information of the target account and the related account (including the friend account).

The monitoring system selection unit 106 selects an appropriate monitoring system 200 from among the plurality of monitoring systems 200, based on the extracted position information of the target user. The monitoring system selection unit 106 refers to a monitoring system list stored in the storage unit 108, and selects the monitoring system 200 that monitors an activity area (position information) of the target user. The monitoring system selection unit 106 selects the monitoring system 200 including the activity area of the target user in a monitoring area (a part or all of the activity area and the monitoring area overlap with each other). A monitoring system 200 that uses a location (around the activity area) within a predetermined range from the activity area as a monitoring area may be selected. In addition, when a plurality of the monitoring systems 200 are equivalent, a plurality of the monitoring systems 200 may be selected. The personal information output unit 107 outputs the extracted personal information of the target user to the selected monitoring system 200.

The monitoring system 200 is a system being installed in a public facility or the like and monitoring a person in the monitoring area. For example, the plurality of monitoring systems 200 monitor different locations (areas) from each other, but a part of each monitoring area may overlap with each other. As illustrated in FIG. 4, the monitoring system 200 includes a monitoring device 201, a monitored person information extraction unit 202, a monitored person information collation unit 203, a collation result output unit 204, a watchlist storage unit 205, and a watchlist generation unit 206.

The monitoring device 201 is a detection device that detects information of a monitored person in the monitoring area. For example, the monitoring device 201 is a biological information sensor that discriminates biological information, a monitoring camera, or the like. The monitoring device 201 may be a monitoring camera, a microphone, or the like installed at an entrance and exit, or a passage of a public facility, or may be a fingerprint sensor or the like installed at an entrance and exit gate.

The monitored person information extraction unit 202 extracts personal information of the monitored person from information detected by the monitoring device 201. For example, when the monitoring device 201 is a camera, the monitored person information extraction unit 202 extracts a face image or a fingerprint of a person from an image captured by the camera, when the monitoring device 201 is a fingerprint sensor, the monitored person information extraction unit 202 acquires fingerprint information of a person from a fingerprint sensor, and when the monitoring device 201 is a microphone, the monitored person information extraction unit 202 extracts voiceprint information of a person from a voice picked up by the microphone. In addition, soft biometric information, belongings, a name, attribute information, and the like may be extracted by analyzing an image of a camera, for example.

The watchlist storage unit 205 is a database that stores a watchlist being a list of targets to be monitored. For example, the watchlist is a face database that stores a face image, a fingerprint database that stores fingerprint information, a voiceprint database that stores voiceprint information, or the like. The watchlist generation unit (registration unit) 206 registers personal information being output from the monitoring assistance device 100 in the watchlist. In other words, the watchlist generation unit 206 registers, in the watchlist, biological information such as a face image, fingerprint information, and voiceprint information of the target user, soft biometric information, belongings, a name, and attribute information. Note that, when the personal information (new personal information) of the target user is registered, the personal information may be added to an existing watchlist, or may be registered in another watchlist (a need-for-caution list, or the like, different from a searched offender list).

The monitored person information collation unit 203 compares and collates the personal information of the monitored person extracted from the monitoring device 201 with the personal information of the watchlist stored in the watchlist storage unit 205. The collation result output unit 204 outputs a collation result of the personal information of the monitored person and the personal information of the watchlist to a monitoring person. When the personal information of the monitored person coincides with the personal information of the watchlist, the collation result output unit 204 outputs an alert by a display or a sound. Coincidence of the personal information may be determined based on, for example, whether a similarity degree of a feature extracted from each piece of information is larger than a predetermined threshold value. In addition, when the personal information of the target user is registered in another watchlist, an alert different from an existing alert may be output for a collation result of the another watchlist. When the personal information includes a plurality of pieces of information (biological information, soft biometric information, belongings, a name, attribute information, and the like), a degree of coincidence (similarity) of each piece of information or a score acquired by summing each degree of coincidence may be output. In addition, among pieces of the information included in the personal information, information that cannot be detected by the monitoring device 201 may be displayed or the like as reference information.

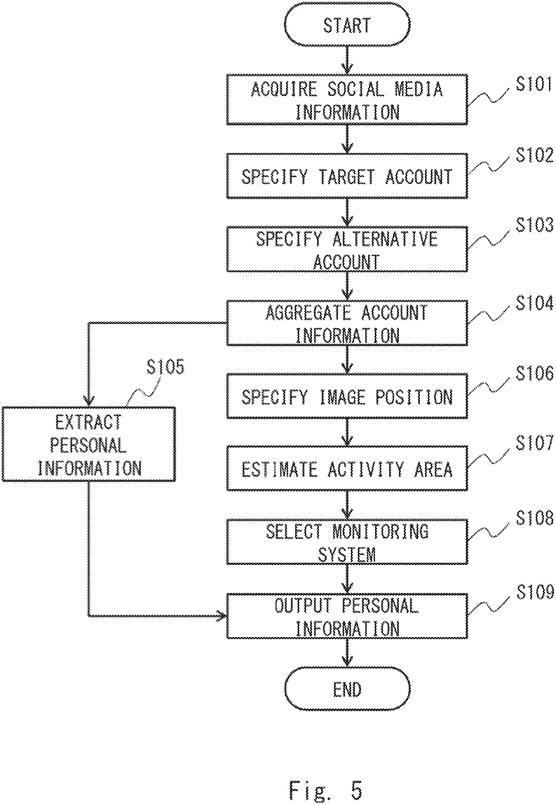

FIG. 5 illustrates one example of an operation (monitoring assistance method) of the monitoring assistance device according to the present example embodiment. As illustrated in FIG. 5, first, the monitoring assistance device 100 acquires social media information from the social media system 300 (S101). The social media information acquisition unit 101 accesses a server or a database of the social media system 300, and acquires social media information of all accounts being published and acquirable. For example, the social media information is acquired to an extent possible by an API (acquisition tool) of the social media service.

Next, the monitoring assistance device 100 specifies a target account to be monitored (S102). The account specification unit 102 may accept an input of information on the target account, and specify the target account, based on the input information. For example, a user of a system may prepare a target person list having high possibility to be involved in a crime, based on information on the Internet, and input information of the target account in the target person list. An account may be specified by inputting an account ID (discrimination information) of the target account, or may be specified by searching the social media information from an input name or the like. In addition, the account specification unit 102 may specify the target account from a predetermined keyword related to a crime such as a crime advance notice. For example, a list of predetermined keywords may be input, or registered in the storage unit 108, social media information may be searched from a keyword, and the target account may be specified.

Next, the monitoring assistance device 100 specifies an alternative account of the target account (S103). For example, the account specification unit 102 specifies a related account related to the target account. The account specification unit 102 may specify a related account related to each account by using a social graph being data representing a connection between users, and acquire account information of the specified related account. For example, an account having an acquaintanceship such as a friend of a target account, a following-up, or a follower, an account having posted information that cites posted information of the target account, an account having a history of giving “like” or the like to posted information of the target account, and an account having a history of browsing account information including a profile and posted information of the target account may be used as the related account. Herein, in particular, an alternative account held by the same user as the target account is specified. Based on information of the target account, the account specification unit 102 searches social media information for information of the related account having a connection with the target account, and extracts an account having high possibility to be held by the same user. For example, the account specification unit 102 may calculate a similarity degree (similarity score) between account information of the target account and account information of the extracted related account, and determine account information of the same user as the target account, based on the calculated similarity degree.

Next, the monitoring assistance device 100 aggregates account information of the specified account (S104). The account information extraction unit 103 extracts account information of the specified target account and account information of the alternative account from the acquired social media information, and aggregates the extracted information. For example, when the account ID of the account is specified, the account information extraction unit 103 extracts and aggregates profile information and posted information of the account associated with the account ID. Note that, account information of another related account, not limited to the alternative account, may be extracted as necessary.

Subsequently to S104, the monitoring assistance device 100 extracts personal information of the target user, based on the aggregated account information (S105). The personal information extraction unit 104 extracts personal information of the target user, based on the account information of the target account and the account information of the alternative account being extracted and aggregated. For example, the profile information in the account information includes text indicating a profile of the account (user) and an image of the account, and the personal information extraction unit 104 extracts attribute information such as a face image, a name, age, and gender of the target user by performing a text analysis or an image analysis on the text or the image. In addition, the posted information includes text, an image, a moving image, and a voice posted by an account (user) on a timeline or the like, and the personal information extraction unit 104 extracts, in addition to the above-described information, a fingerprint, a voiceprint, other soft biometric information, belongings, and the like of the target user by performing the text analysis, the image analysis, or a voice analysis on the text, the image, or the voice.

In addition, subsequently to S104, in S106 and S107, the monitoring assistance device 100 extracts position information of the target user, based on the aggregated account information. For example, the position information extraction unit 105 may acquire the position information from a place of residence, a native place, and the like in the profile information included in the extracted and aggregated account information. In addition, the position information extraction unit 105 may acquire the position information from a word being capable of specifying a position among pieces of the posted information included in the account information. Further, the position information extraction unit 105 may acquire the position information from a GEO tag when the posted information included in the account information is provided with information, referred to as the GEO tag, being capable of specifying a current position of a posted person. In addition, the position information extraction unit 105 may acquire the position information by using a geo-location. Further, when any one of pieces of the posted information and the geo-location is used, the position information extraction unit 105 may use the acquired position information having the largest number of times of acquisition.

Herein, the position information of the target user is extracted by image position specification processing (S106) and activity area estimation processing (S107). In the image position specification processing (S106), the image position specification unit 110 specifies a visit location (posted location) from projection in the posted image or the moving image (acquired image) included in the aggregated account information. The projection is, for example, an object related to a location of a building, a sign, a road, or the like, which is projected in an image. The image position specification unit 110 refers to an image database (position image) with position information with which the position information is associated, and collates the posted image with each position image of the image database with position information. The image database with position information may be stored in the storage unit 108, or may be an external database. For example, an object projecting in a posted image may be extracted by the image analysis, and the projecting object may be collated with each position image of the image database with position information. Based on the collation result, the image position specification unit 110 specifies a capturing location of the posted image from the position information associated with the coincided position image.

Note that, an amount of images in the image database with position information may be enormous. Therefore, a search range of the image database with position information may be narrowed down, based on account information or the like. In other words, the position image related to the target account among the position images in the image database with the position information and the posted image (acquired image) may be collated with each other. For example, among the position images in the image database with position information, a position image associated with activity base information such as a residential area (e.g., Tokyo, Kawasaki City in Kanagawa Prefecture) described in a profile or the like of the target account or a position image associated with activity base information such as a residential area described in a profile of the related account (friend account) having a connection with the target account may be used as a collation target. As a result, collation accuracy and search speed can be improved.

In addition, in the activity area estimation processing (S107), the activity area estimation unit 120 estimates an activity area of the target user from various pieces of position information extracted from the aggregated account information (including a friend account). The activity area estimation unit 120 estimates the activity area from a plurality of pieces of position information including the position information extracted by the image position specification processing. For example, the activity area estimation unit 120 extracts an activity base or a visit location such as a place of residence of the target user from account information of the target account (including an alternative account) and the friend account (related account), extracts an activity base or a visit location such as a place of residence of the friend user from the account information of the friend account, and sets an area including these locations as an activity area.

Note that, each piece of processing may be performed in order of S106 and S107, or each pieces of processing may be performed in order of S107 and S106. In other words, the position information extraction unit 105 may specify a visit location of the target user from projection of the posted image of the aggregated account information (S106), estimate the activity area of the target user from various pieces of position information (including the position specified in S106) including the friend account (S107), and extract the activity area (position information) of the target user. In addition, the position information extraction unit 105 may estimate the activity area of the target user from various pieces of position information of the aggregated account information (including the friend account) (S107), specify the visit location of the target user from the projection of the posted image within a range of the estimated activity area (S106), and extract the activity area of the target user.

Next, the monitoring assistance device 100 selects the monitoring system 200, based on the position information of the target user extracted in S106 and S107 (S108). The monitoring system selection unit 106 refers to the monitoring system list stored in the storage unit 108, and selects a monitoring system including the activity area (around the activity area) of the target user in the monitoring area.

The monitoring system selection unit 106 may select the monitoring system 200 of a public facility such as a railway or an airport around the position information of the target user. For example, the monitoring system selection unit 106 may calculate a congestion degree (a person or a vehicle) of a location or a facility, and select the monitoring system 200, based on the calculated congestion degree. For example, the congestion degree is calculated by using the number of persons, the number of vehicles, and the like. The monitoring system selection unit 106 may select a location around the position information of the target user, a location within the facility being currently or normally congested, or expected to be congested in the future, or a facility. As a result, a location that can be a soft target can be monitored. In addition, the monitoring system selection unit 106 may select a monitoring system 200 of public transportation such as a railway or a bus, which can be a moving route of the target user, based on the position information of the target user.

In addition, when there are a plurality of candidates for the position information of the target user, the monitoring system selection unit 106 may select a plurality of monitoring systems 200 around a plurality of pieces of the position information. For example, the monitoring system selection unit 106 may set a score indicating possibility that the target user is located to a candidate of the position information of the target user, and select the monitoring system 200, based on the set score. The score is set based on, for example, the number of visits and a frequency of visits of the target account or the friend account, a distance between locations, a weight of the friend relationship, and the like. The monitoring system selection unit 106 may select the monitoring system 200 around the position information of only the top N candidates with the set score.

Subsequently to S105 and S108, the monitoring assistance device 100 outputs personal information of the target user (S109). The personal information output unit 107 outputs the personal information of the target user extracted in S105 to the monitoring system 200 selected in S108. As a result, the extracted personal information of the target user is registered in a watchlist of the monitoring system 200 being provided around the activity area of the target user. Note that, the personal information output unit 107 may output the personal information and the position information of the target user to all the monitoring systems 200. In this case, the monitoring system 200 compares the received position information of the target user with the monitoring area of the own system, and when the position information coincides with the monitoring area, registers the received personal information of the target user in a watch area.

As described above, in the present example embodiment, in the monitoring assistance device, personal information and position information of a target user are extracted from account information related to a target account, and the extracted personal information is registered in a watchlist of the monitoring system provided around the extracted position information. As a result, it is possible to specify position information of a target person related to a crime using cyberspace, and to monitor a location where the target person is highly possible to be located. Therefore, the target person can be efficiently monitored, and the target person can be effectively detected before executing a crime in the physical space.

In general, it is difficult to acquire position information of a person, and in particular, in a law enforcement agency, it is difficult to specify a location of a person involved in a crime using cyberspace. In the present example embodiment, it is possible to reliably acquire position information of a target user by using an account collation technique for specifying an alternative account of the target user, an image position specification technique for specifying a visit location of the target user from projection of a posted image or the like, and an activity area estimation technique for estimating an activity range of the target user by also using information of a friend user.

### Second Example Embodiment

Next, a second example embodiment will be described with reference to the drawings. In the present example embodiment, one example of alternative account specification processing (S103 in FIG. 5) according to the first example embodiment will be described. Note that, a configuration and other processing of a monitoring assistance device 100 are similar to those of the first example embodiment.

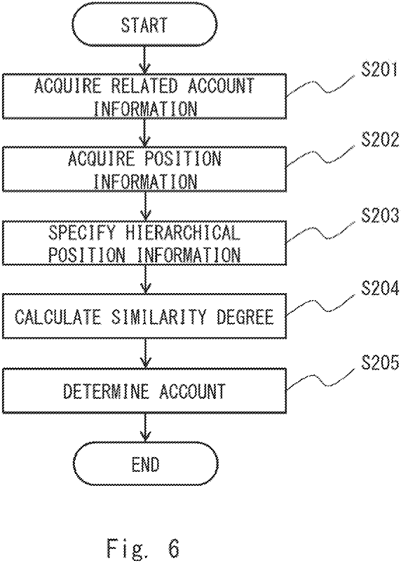

FIG. 6 illustrates an example of alternative account specification processing according to the present example embodiment. Herein, an example of determining whether two accounts to be determined (referred to as a “determination account”) are accounts held by the same user will be described. In other words, the two accounts finally determined to be accounts held by the same user are equivalent to a target account and an alternative account specified in the first example embodiment. Note that, the following processing is mainly executed by an account specification unit 102 of the monitoring assistance device 100, but may be executed by another unit as necessary. In this example, the account specification unit 102 specifies an alternative account, based on position information acquired from account information of a related account, in particular, specifies hierarchical position information acquired by hierarchizing the acquired position information according to a granularity level of the position, and specifies the alternative account, based on the specified hierarchical position information.

As illustrated in FIG. 6, first, the account specification unit 102 acquires information of a related account being related to two determination accounts (S201). The account specification unit 102 specifies two determination accounts from collected social media information, and acquires account information of the related account related to the two determination accounts. Similarly to the first example embodiment, the account specification unit 102 may specify a related account having a connection with each determination account, and acquire account information of the specified related account.

Next, the account specification unit 102 acquires position information associated with each related account (S202). Similarly to the position information extraction unit 105 according to the first example embodiment, the position information of the related account may be acquired. For example, the account specification unit 102 may acquire the position information from a place of residence, a native place, or the like in profile information included in the account information of the related account, or may acquire the position information from an image, text, or the like in posted information included in the account information of the related account.

Next, the account specification unit 102 specifies the hierarchical position information of each related account, based on the position information of each related account (S203). The account specification unit 102 specifies the hierarchical position information indicating the hierarchized position information according to the granularity level of the position, based on the acquired position information of the related account. Further, the account specification unit 102 generates a hierarchical position information table in which hierarchical position information of each related account is set for each determination account.

The granularity level may be, for example, a level associated with a country unit or an administrative district unit. For example, when three levels are defined as the granularity level, the granularity level of the lowest level may be set as a country unit level, the granularity level of the second lowest level may be set as a prefectural unit, and the granularity level of the third lowest level may be set as a municipal unit. The account specification unit 102 specifies position information of which granularity level the acquired position information is, and specifies position information in “country” unit, position information in “prefecture” unit, and position information in “municipality” unit, based on the acquired position information. For example, in a case where an SNS prepares a place of residence or a native place of a user included in profile information as a format for registering information of “country”, “prefecture”, and “municipality”, the hierarchical position information with the granularity level of “country”, “prefecture”, and “municipality” may be specified according to the above format. For example, when the acquired position information is “Fuchu City”, the hierarchical position information of the acquired position information may be specified as the position information with the granularity level in “municipality” unit, the hierarchical position information in “prefecture” unit having the granularity level lower than that of “municipality” unit may be specified as “Tokyo”, and further the hierarchical position information is “country” unit may be specified as “Japan”.

Next, the account specification unit 102 calculates a similarity degree between the two determination accounts (S204). The account specification unit 102 refers to the hierarchical position information table for each generated determination account, and calculates the similarity degree between the determination accounts by using the hierarchical position information set in the hierarchical position information table. Specifically, the account specification unit 102 counts the number of pieces of data of the hierarchical position information for each granularity level in the hierarchical position information table of each determination account, and normalizes the counted number of pieces of data. The account specification unit 102 multiplies the normalized values in the two determination accounts by each other, and sets a value acquired by multiplying as an evaluation value of each piece of the data. The account specification unit 102 calculates the sum of the evaluation values of all pieces of the data being common to the two determination accounts as the similarity degree for each granularity level between the two determination accounts. Further, the account specification unit 102 calculates the sum of the similarity degrees for each of all the granularity levels as the similarity degree between the two determination accounts.

Next, the account specification unit 102 determines whether the two determination accounts are accounts of the same user (S205). The account specification unit 102 determines whether the two determination accounts are accounts held by the same user, based on the calculated similarity degree between the determination accounts. Specifically, when the similarity degree between the two determination accounts is equal to or more than a predetermined threshold value, the account specification unit 102 determines that a user holding the two accounts is identical. Note that, the account specification unit 102 may specify an account held by the same user from the similarity degree of the position information (hierarchical position information table) of the related account for all the accounts included in the social media information.

As described above, in the present example embodiment, an alternative account held by the same user is specified, based on position information acquired from account information of a related account being related to a determination account. In addition, based on the position information of the related account, hierarchical position information indicating position information hierarchized according to a granularity level of a position is specified, and an alternative account is specified by using the specified hierarchical position information. Further, the hierarchical position information is specified for each determination account, a similarity degree between determination accounts is calculated by using the hierarchical position information, and an alternative account is specified, based on the calculated similarity degree. As a result, even when information of the determination account includes a false content or information different from actual information is registered, an account held by the same user can be accurately specified. Therefore, it is possible to accurately specify an account in which a user is identical, regardless of information registered by the user.

### Third Example Embodiment

Next, a third example embodiment will be described with reference to the drawings. In the present example embodiment, another example of alternative account specification processing (S103 in FIG. 5) according to the first example embodiment will be described. Note that, a configuration and other processing of a monitoring assistance device 100 are similar to those of the first example embodiment.

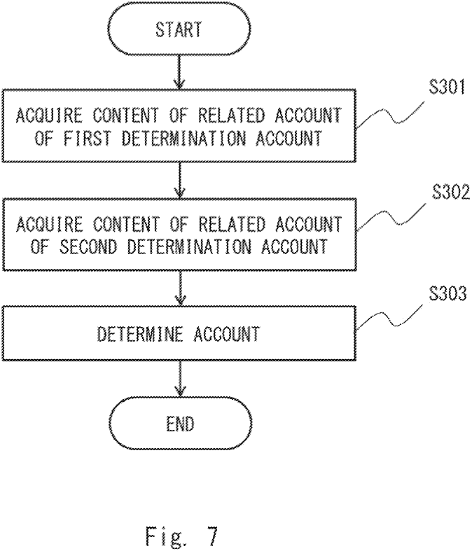

FIG. 7 illustrates an example of alternative account specification processing according to the present example embodiment. Herein, an example of determining whether two accounts to be determined (referred to as a “determination account”) are accounts held by the same user will be described. In other words, the two accounts finally determined to be accounts held by the same user are equivalent to a target account and an alternative account specified in the first example embodiment. Note that, the following processing is mainly executed by an account specification unit 102 of the monitoring assistance device 100, but may be executed by another unit as necessary. In this example, the account specification unit 102 specifies an alternative account, based on content data acquired from account information of a related account.

As illustrated in FIG. 7, first, the account specification unit 102 acquires a content of a related account being related to a first determination account (S301). The account specification unit 102 specifies the first determination account from collected social media information, and acquires account information of a related account being related to the first determination account. Similarly to the first example embodiment, the account specification unit 102 may specify a related account having a connection with the first determination account, and acquire account information of the specified related account. Further, the account specification unit 102 extracts a content associated with the related account from the acquired account information of the related account. For example, the content is image data uploaded associated with the related account, or the like, and the content is acquired from posted information of the account information.

Next, the account specification unit 102 acquires a content of a related account being related to a second determination account (S302). Similarly to S301, the account specification unit 102 specifies the second determination account, acquires account information of the related account being related to the second determination account, and extracts a content associated with the related account from the acquired account information.

Next, the account specification unit 102 determines whether the first determination account and the second determination account are accounts of the same user (S303). Specifically, the account specification unit 102 determines whether the acquired content of the related account being related to the first determination account is similar to the acquired content of the related account being related to the second determination account, and when the content is similar, determines that the two determination accounts are accounts held by the same user. For example, when a similarity degree is higher than a predetermined threshold value, it may be determined that the accounts are held by the same user.

The account specification unit 102 may determine the similarity degree of all the acquired contents, or may determine only a predetermined type of contents, such as image data. The account specification unit 102 may acquire, for example, a similarity degree of an object detected from the image data. The object to be determined may be an object of any type, or may be an object of a specific type. When an object of a specific type is determined, for example, the similarity degree of only a person among objects included in the image data may be acquired.

In addition, the account specification unit 102 may acquire the similarity degree of a topic of image data included in a content. The topic is a main matter or event represented by the data, such as work, meals, sports, travel, games, or politics. Further, the account specification unit 102 may extract a keyword from text data included in the content, and acquire the similarity degree of the text data. In addition, the account specification unit 102 may extract a keyword or a voiceprint from voice data such as simple voice data included in the content or voice data included in a moving image, and acquire the similarity degree of the voice data. Note that, the account specification unit 102 may specify an account held by the same user from the similarity degree of the contents of the related account for all the accounts included in the social media information.

As described above, in the present example embodiment, an alternative account held by the same user is specified, based on content data acquired from account information of a related account being related to a determination account. In addition, for each determination account, content data associated with the determination account are acquired, and an alternative account is specified according to whether the acquired content data is similar (according to a similarity degree). In an account held by the same user, there is a high probability that a user is publishing similar information, therefore it is possible to accurately specify an account in which a user is identical.

### Fourth Example Embodiment

Next, a fourth example embodiment will be described with reference to the drawings. In the present example embodiment, one example of account information aggregation processing (S104 in FIG. 5) according to the first to third example embodiments will be described. Note that, a configuration and other processing of a monitoring assistance device 100 are similar to those of the first to third example embodiments.

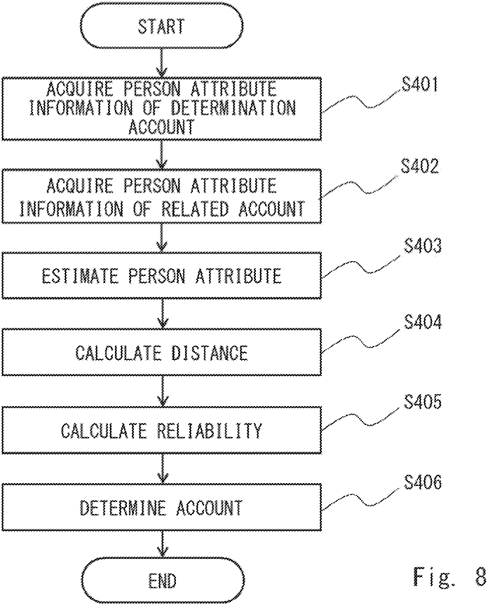

FIG. 8 illustrates an example of account information aggregation processing according to the present example embodiment. Herein, an example in which reliability of an account to be determined (referred to as a determination account) is calculated and an account to be aggregated is determined will be described. For example, in the first example embodiment, when the reliability of a specified alternative account is higher than the reliability of a target account, information of only the alternative account may be aggregated. In other words, account information of an account finally determined to be an account having high reliability among the determination accounts including the target account and the alternative account may be aggregated. Note that, the following processing is mainly executed by an account information extraction unit 103 of the monitoring assistance device 100, but may be executed by another unit as necessary. The account information extraction unit 103 can also be referred to as a reliability calculation unit that calculates reliability of a target account and a related account (alternative account). For example, a personal information extraction unit 104 and a position information extraction unit 105 extract personal information and position information, based on account information of one of a target account and a related account, and extract the personal information and the position information, based on account information of an account having high reliability among the target account and the related account. In this example, the reliability is based on person attribute information acquired from the account information of the target account and the related account.

As illustrated in FIG. 8, first, the account information extraction unit 103 acquires person attribute information of a determination account (S401). Similarly to the first example embodiment, the account information extraction unit 103 may acquire the account information of the determination account from collected social media information. Further, the account information extraction unit 103 extracts the person attribute information included in profile information from the acquired account information of the determination account.

Next, the account information extraction unit 103 acquires person attribute information of a related account (S402). Similarly to the first example embodiment, the account information extraction unit 103 may acquire account information of the related account being related to the determination account from the collected social media information. Further, the account information extraction unit 103 extracts the person attribute information included in profile information from the acquired account information of the related account. For example, the related account may be a friend account included in a friend account list of the determination account.

Next, the account information extraction unit 103 estimates a person attribute of a user (determination user) of the determination account (S403). The account information extraction unit 103 estimates the person attribute of a determination user holding the determination account, based on the person attribute information of the acquired related account (friend account). For example, when a place of residence is included in the person attribute information of the related account, a place of residence of the determination user is estimated, based on a physical distance from the place of residence.

Next, the account information extraction unit 103 calculates a distance between the person attribute information of the determination account acquired in S401 and the person attribute of the determination user estimated in S403 (S404). For example, the account information extraction unit 103 calculates a distance by using information of the same category among the acquired person attribute information and the estimated person attribute. Specifically, the account information extraction unit 103 may calculate a physical distance between the place of residence included in a profile of the determination account and the place of residence of the determination user estimated from the related account.

In addition, the category for calculating a distance may be at least one of differences in demographic (artificial statistical) attribute such as age, gender, income, educational background (e.g., a deviation value or an inter-field distance), an occupation (e.g., blue or white color, inter-industry distance), family composition, and the like. The calculation may be performed by a method based on an inter-field/inter-industry distance (e.g., a ratio of field-changing/job-changing to a different field/industry (a transition probability)). In addition, the category for calculating a distance may be at least one of differences in psychographic (psychological) attribute such as a hobby preference (e.g., indoor/outdoor), a purchasing trend, and the like.

Next, the account information extraction unit 103 calculates reliability of the determination account, based on the calculated distance (S405). The reliability may be a numerical index acquired by the distance.

Next, the account information extraction unit 103 determines an account to be aggregated, based on the calculated reliability (S406). When the reliability of the determination account is more than a predetermined threshold value, the account information extraction unit 103 determines that the determination account is an account to be aggregated. For example, the reliability of the two determination accounts (the target account and the alternative account) may be calculated, and it may be determined that only the account having the higher reliability is an account to be aggregated.

As described above, in the present example embodiment, for each determination account, reliability of the determination account is calculated, based on person attribute information acquired from account information of the determination account. In addition, the reliability of the determination account is calculated, based on person attribute information of a related account being related to the determination account. Further, a person attribute of the determination account is estimated, based on the person attribute information of the related account, and the reliability of the determination account is calculated, based on a distance between the person attribute information of the determination account to be acquired and the person attribute of the determination account to be estimated. As a result, it is possible to determine the reliability of the determination account (whether it is a fake account, and the like), and therefore, it is possible to aggregate only information of an account having the high reliability. Note that, an alternative account held by the same user may be specified by using the reliability calculated in the present example embodiment.

### Fifth Example Embodiment

Next, a fifth example embodiment will be described with reference to the drawings. In the present example embodiment, one example of an image position specification unit (an image position specification unit 110 in FIG. 3) and image position specification processing (S106 in FIG. 5) according to the first to fourth example embodiments will be described. Note that, another configuration and other processing of a monitoring assistance device 100 are similar to those of the first to fourth example embodiments.

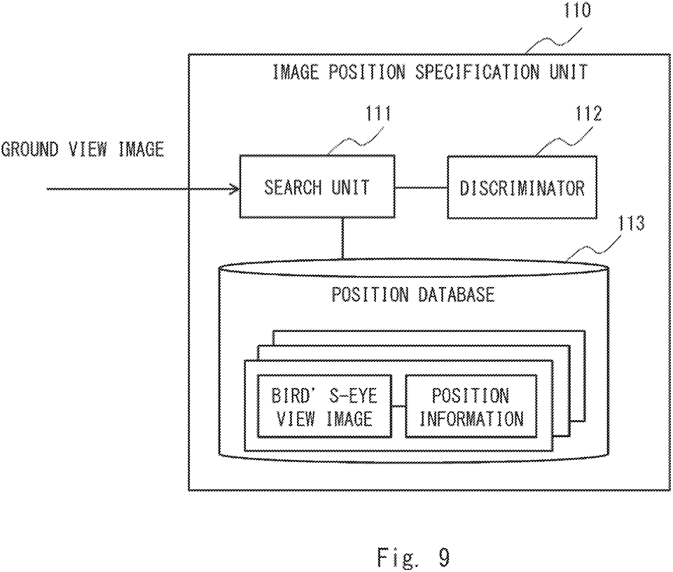

FIG. 9 illustrates a configuration example of an image position specification unit 110 of the monitoring assistance device 100 according to the present example embodiment. As illustrated in FIG. 9, the image position specification unit 110 includes a search unit 111, a discriminator 112, and a position database 113. For example, the position database 113 may be included in a storage unit 108 of the monitoring assistance device 100.

A ground view image is input to the image position specification unit 110. The ground view image is an image acquired by capturing a certain location (position) from a camera on the ground such as a pedestrian or a car in a ground view. A ground image may be a panoramic image having a field of view of 360 degrees, or may be an image having a predetermined field of view of less than 360 degrees. For example, an input ground view image is a posted image included in account information of a target account according to the first example embodiment.

The position database 113 is an image database with position information, and stores a plurality of bird’s-eye view images (position images) associated with position information. For example, the position information is a GPS coordinate or the like of a position at which a bird’s-eye view image is captured. The bird’s-eye view image is an image acquired by capturing a certain location from a camera above such as a drone, an airplane, or a satellite in a bird’s-eye view (in a plan view).

The search unit 111 acquires a ground view image for specifying position information. The search unit 111 searches the position database 113 for a bird’s-eye view image coinciding with the acquired ground view image, and determines a position at which the ground view image is captured. Specifically, processing of sequentially acquiring the bird’s-eye image from the position database 113 is repeated until a bird’s-eye image coinciding with a ground view image is detected. In this example, a ground view image and a bird’s-eye view image are input to the discriminator 112, whether an output of the discriminator 112 indicates coincidence between the ground view image and the bird’s-eye view image is determined, and thereby a bird’s-eye view image including a position at which the ground view image is captured is found. The search unit 111 specifies a position at which a ground view image (an acquired image such as a posted image) is captured, based on position information associated with the detected bird’s-eye view image.

The discriminator 112 acquires a ground view image and a bird’s-eye view image, and discriminates whether the acquired ground view image and the acquired bird’s-eye view image coincide with each other. Note that, “a ground view image and a bird’s-eye view image coincide with each other” means that the position at which the ground view image is captured is included in the bird’s-eye view image. Discrimination by the discriminator 112 can be achieved in various methods. For example, the discriminator 112 extracts a feature of a ground view image and a feature of a bird’s-eye view image, and calculates a similarity degree between the feature of the ground view image and the feature of the bird’s-eye view image. The discriminator 112 determines that the ground view image and the bird’s-eye view image coincide with each other when the calculated similarity degree is high (e.g., when the calculated similarity degree is equal to or more than a predetermined threshold value), on the other hands, determines that the ground view image and the bird’s-eye view image do not coincide with each other when the calculated similarity degree is low (e.g., when the calculated similarity degree is less than the predetermined threshold value). For example, the discriminator 112 is generated by performing machine learning (training) in advance on a relationship between a ground view image and a plurality of bird’s-eye images.

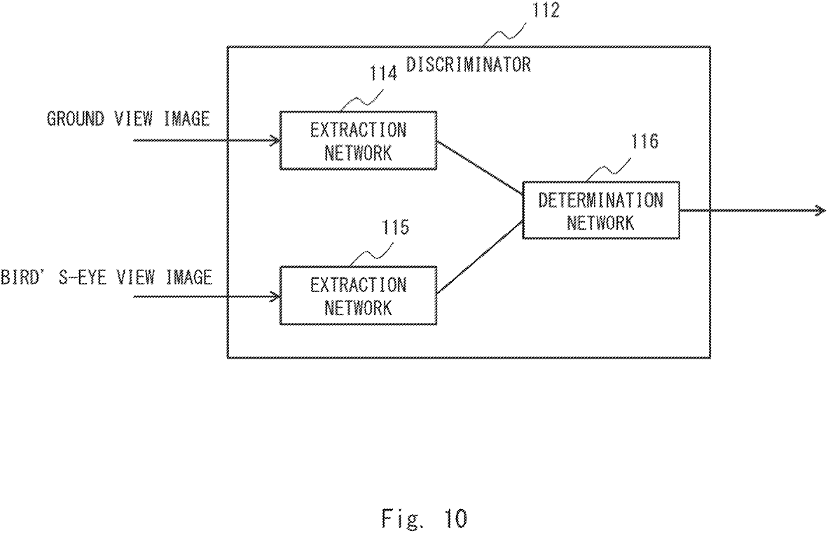

FIG. 10 illustrates a configuration example of the discriminator 112 according to the present example embodiment. FIG. 10 is an example in which the discriminator 112 is implemented by a plurality of neural networks. As illustrated in FIG. 10, the discriminator 112 includes an extraction network 114, an extraction network 115, and a determination network 116.

The extraction network (first extraction unit) 114 is a neural network that acquires a ground view image, generates a feature map of the acquired ground view image (extracts a feature of the ground view image), and outputs the generated feature map. The extraction network (second extraction unit) 115 is a neural network that acquires a bird’s-eye view image, generates a feature map of the acquired bird’s-eye view image (extracts a feature of the bird’s-eye view image), and outputs the generated feature map. The determination network (determination unit) 116 is a neural network that analyzes the generated feature map of the ground view image and the generated feature map of the bird’s-eye view image, and outputs whether the ground view image and the bird’s-eye view image coincide with each other.

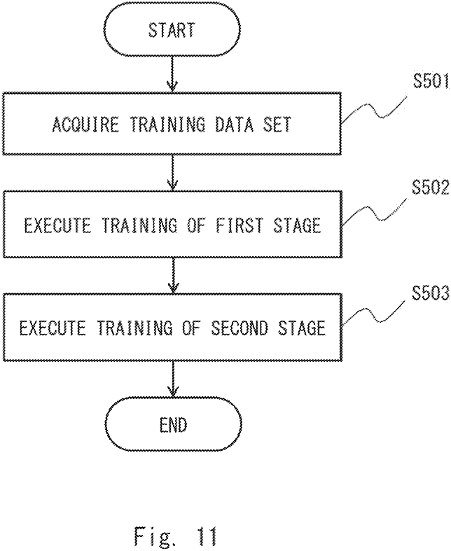

FIG. 11 illustrates training processing (learning method) of the discriminator 112 according to the present example embodiment. The training processing may be performed by the monitoring assistance device 100, or may be performed by another training device (not illustrated). Herein, it will be described as being performed by the training device.

First, the training device acquires a training data set (S501). The training device acquires a training data set including a ground view image and a bird’s-eye view image associated with position information, which are prepared in advance. The training data set includes a ground view image, a positive example of a bird’s-eye view image, a negative example of a first level of the bird’s-eye view image, and a negative example of a second level of the bird’s-eye view image. Note that, the positive example is a bird’s-eye view image that coincides with an associated ground view image (a distance between the images is equal to or less than a predetermined threshold value). The negative example is a bird’s-eye view image that does not coincide with the associated ground view image (the distance between the images is more than the predetermined threshold value).

A similarity degree of the negative example of the first level with respect to a ground view image is different from a similarity degree of the negative example of the second level with respect to a horizon view image. For example, each bird’s-eye view image is associated with information indicating a type of a landscape included in the bird’s-eye view image. The negative example of the first level includes a landscape of a different type from a landscape included in the associated ground view image, and the negative example of the second level includes a landscape of the same type as a landscape included in the associated ground view image. This means that the similarity degree of the negative example of the first level with respect to the associated ground view image is lower than the similarity degree of the negative example of the second level with respect to the associated ground view image.

Next, the training device executes training of a first stage of the discriminator 112 (S502). The training device inputs the ground view image and the positive example to the discriminator 112, and updates a parameter of the discriminator 112 by using an output of the discriminator 112. In addition, the ground view image and the negative example of the first level are input to the discriminator 112, and the parameter of the discriminator 112 is updated by using the output of the discriminator 112. First, in the training of the first stage, a set of neural networks is trained by using a ground view image, a positive example, and a loss function (positive loss function) of the positive example. The positive loss function is designed in such a way as to train the discriminator 112 and output a greater similarity degree between the ground view image and the positive example.

In the discriminator 112 in FIG. 10, each of the ground view image and the positive example is input to the extraction network 114 and the extraction network 115, respectively. Then, the output from the set of neural networks is input to the positive loss function, and the parameter (weight) assigned to each connection between nodes in the neural network constituting the discriminator 112 is updated based on the calculated loss. Further, in the training of the first stage, a set of neural networks is trained by using a ground view image, a negative example, and a loss function (negative loss function) of the negative example. The negative loss function is designed in such a way as to train the discriminator 112 and output a smaller similarity degree between the ground view image and the negative example.

In addition, in the discriminator 112 in FIG. 10, each of the ground view image and the negative example is input to the extraction network 114 and the extraction network 115, respectively. Then, the output from the set of neural networks is input to the negative loss function, and the parameter (weight) assigned to each connection between the nodes in the neural networks constituting the discriminator 112 is updated based on the calculated loss.

Next, the training device executes training of a second stage of the discriminator 112 (S503). The training of the second stage is similar to the training of the first stage except that a negative example of the second level is used. In other words, the ground view image and the positive example are input to the discriminator 112, and the parameter of the discriminator 112 are updated by using the output of the discriminator 112. In addition, the ground view image and the negative example of the second level are input to the discriminator 112, and the parameter of the discriminator 112 is updated by using the output of the discriminator 112.

As described above, according to the present example embodiment, training (learning) is performed by using a bird’s-eye view image and a ground view image in which position information is associated in advance, an acquired discriminator is used, and thereby a location where the ground view image is captured is specified. As a result, it is possible to reliably specify a place where a posted image is captured.

### Sixth Example Embodiment

Next, a sixth example embodiment will be described with reference to the drawings. In the present example embodiment, one example of activity area estimation processing (S107 in FIG. 5) according to the first to fifth example embodiments will be described. Note that, a configuration and other processing of a monitoring assistance device 100 are similar to those of the first to fifth example embodiments.

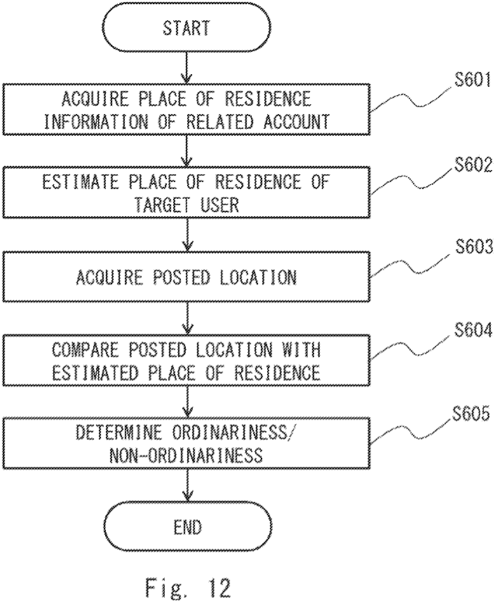

FIG. 12 illustrates an example of activity area estimation processing according to the present example embodiment. Herein, an example of determining ordinariness/non-ordinariness of a posted location will be described. In other words, a location determined to have high ordinariness is a location included in an activity area of a target user according to the first example embodiment. Note that, the following processing is mainly executed by an activity area estimation unit 120 of the monitoring assistance device 100, but may be executed by another unit as necessary. In this example, the activity area estimation unit 120 estimates an activity area of a target user according to whether a location specified from account information of a target account or a related account is an ordinary or non-ordinary activity location of the target user.

As illustrated in FIG. 12, first, the activity area estimation unit 120 acquires place of residence information of a related account (S601). Similarly to the first example embodiment, the activity area estimation unit 120 may acquire account information of the related account being related to a target account from collected social information. Further, the activity area estimation unit 120 acquires the place of residence information (activity base information) of the related account from the acquired account information of the related account. For example, the activity area estimation unit 120 may acquire the place of residence information from a place of residence, a native place, or the like of profile information included in the account information of the related account, or may acquire the place of residence information from posted information included in related account information, based on a word that can specify a place of residence.

The place of residence information is information for geographically specifying a place of residence of a user holding an account. The place of residence of a user is a place that serves as a base for the user’s life, and is intended to be a region such as a prefecture or a municipality, but there is no particular limitation on which unit the region is to be divided. For example, a region specified by longitude and latitude of north, south, east, and west end points may be the place of residence of a user. In addition, the place of residence of a user may include a plurality of regions being geographically separated. Further, the place of residence of a user may include a work place, a station on a commuting route, or the like of a related user.

Next, the activity area estimation unit 120 estimates a place of residence of a target user (S602). The activity area estimation unit 120 estimates the place of residence (activity base) of the target user holding the target account, based on the acquired place of residence information of the related account. The activity area estimation unit 120 sets a plurality of pieces of place of residence information of the related account as each of candidates of the place of residence of the target user, calculates, for each of the candidates of the place of residence, a score indicating possibility that the target user lives in the candidate of the place of residence, and estimates the candidate of the place of residence having the largest score or the N candidates of the place of residence having the top N score (N is a positive integer equal to or greater than 1), as the place of residence of the target user. For example, the score may be based on presence or absence of a friend relationship, a distance between places of residence of friends, and the like.

The place of residence to be estimated (estimated place of residence) is information for geographically specifying the place of residence of the target user estimated from the place of residence information. Since the estimated place of residence is estimated from the place of residence information of the related account, the estimated place of residence represents, for example, a region such as a prefecture or a municipality as well as the place of residence information being a source of estimation. In addition, the estimated place of residence may represent, for example, a region specified by longitude and latitude of north, south, east, and west end points, may include a plurality of regions being geographically separated, or may include a work place, a station on a commuting route, or the like.

Next, the activity area estimation unit 120 extracts a posted location from the account information of the target account (S603). Similarly to the first example embodiment, the activity area estimation unit 120 acquires posted information (an acquirable image, or the like) included in the account information of the target account (which may include a related account), and extracts a posted location where the acquired posted information is posted. When a posted content is associated with a capturing location or a current location by information such as a GEO tag, the activity area estimation unit 120 may acquire longitude and latitude of the posted location from associated information. In addition, when information such as a GEO tag is not associated with a posted matter, the activity area estimation unit 120 may estimate a posted position by using a region-specific word, a hash tag, or the like included in a posted sentence. The posted location is information that geographically specifies a location where a content is posted from the target user to social media. The posted location may be an address of the posted location or the longitude and latitude of the posted location.

Next, the activity area estimation unit 120 compares the posted location acquired in S603 with the place of residence estimated in S602 (S604). The activity area estimation unit 120 compares the posted location of the acquired account information of the target account with the estimated place of residence of the target user. A comparison result indicates, for example, whether the posted location is within the estimated place of residence or outside the estimated place of residence.

Next, the activity area estimation unit 120 determines ordinariness or non-ordinariness of the posted location (S605). The activity area estimation unit 120 determines whether the posted location is an ordinary activity location of the target user or a non-ordinary activity location, based on the comparison result between the acquired posted location and the estimated place of residence. For example, when the comparison result indicates that the posted location is within the estimated place of residence, the activity area estimation unit 120 determines that the posted location is an ordinary activity location of the target user. In addition, when the comparison result indicates that the posted location is outside the estimated place of residence, the activity area estimation unit 120 determines that the posted location is a non-ordinary activity location of the target user. For example, when it is determined that the posted location is an ordinary activity location of the target user, the posted location is estimated as an activity area of the target user.

As described above, in the present example embodiment, an activity area of a target user can be specified according to whether a posted location acquired from account information is an ordinary or non-ordinary activity location of the target user. According to the present example embodiment, based on knowledge that friends who have some connection are located in a geographically close location with each other, a place of residence (activity base) of the target user is estimated from place of residence information (activity base information) of a related account being related to a target account. Then, by comparing a place of residence estimated from the related account with the posted location of posted information of the target account, ordinariness/non-ordinariness of the posted location is determined. As a result, it is possible to accurately estimate the activity area of the target user.

Note that, the place of residence of the target user may be estimated from place of residence information of another user (an offline friend) who has an interaction with the target user in physical space. For example, when estimating the place of residence, a score may be calculated by weighting a candidate of a place of residence of the related user being determined to be an offline friend. From among the related users, the related user whose related account is a local account related to a specific region may be selected as an offline friend of the target user.

In addition, ordinariness/non-ordinariness of the posted location may be determined based on a relationship between a location attribute representing an attribute of the posted location and a person attribute representing an attribute of the target user. For example, the location attribute is information indicating whether the posted location is a famous tourist site, whether the posted location is a luxury restaurant, and the like. For example, the person attribute is information indicating a hobby preference, income, an occupation, or the like of the target user. When the location attribute and the person attribute are related (highly related) to each other, the posted location is determined as an ordinary activity location.

Further, it may be determined whether a schedule of a posted date and time of the target user is ordinary or non-ordinary, based on a past behavior history of the target user and a relationship between a future schedule and the posted date and time. When there is a relationship between the schedule of the posted date and time and the location attribute, whether the schedule of the target user at the posted date and time is ordinary or non-ordinary is determined based on a viewpoint of a purpose of the behavior, periodicity, and the like. For example, when the schedule of the posted date and time is an outpatient visit performed for a certain period of time or at a certain frequency, it is determined that the schedule is ordinary. In addition, when the schedule of the posted date and time is a business trip or homecoming for a certain period of time, or participation in an event participating in every year, it is determined that the schedule is ordinary. In addition, when the schedule of the posted date and time is participation in a single event or business trip, it is determined that the schedule is non-ordinary.

In addition, ordinariness/non-ordinariness of the posted location may be determined based on a relationship between the posted location and a friend posted area of the friend account. The friend posted area is information on an area of a posted location of a related user generated based on a location where the user of the related account posted a content on the social media. The friend posted area and the posted location are compared geographically with each other, and ordinariness/non-ordinariness is determined based on a comparison result of the posted location and the estimated place of residence, and a comparison result of the friend posted area and the posted location. For example, when the posted location indicates that the posted location is outside the estimated place of residence, and the posted location indicates that the posted location is within the friend posted area, it is determined that the posted location is within the ordinary activity location of the target user. In addition, when the posted location indicates that the posted location is within the estimated place of residence, it is determined that the posted location is the ordinary location of the target user.

### Seventh Example Embodiment

Next, a seventh example embodiment will be described with reference to the drawings. In the present example embodiment, another example of activity area estimation processing (S107 in FIG. 5) according to the first to fifth example embodiments will be described. Note that, a configuration and other processing of a monitoring assistance device 100 are similar to those of the first to fifth example embodiments.

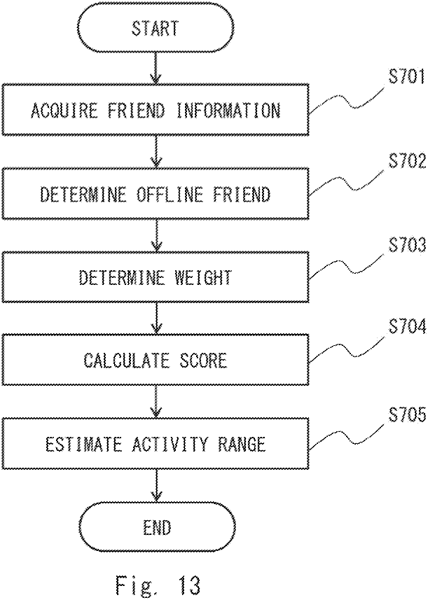

FIG. 13 illustrates an example of activity area estimation processing according to the present example embodiment. Note that, the following processing is mainly executed by an activity area estimation unit 120 of the monitoring assistance device 100, but may be executed by another unit as necessary. In this example, the activity area estimation unit 120 estimates an activity area of a target account, based on a location specified from account information of a related account (offline friend) having a friend relationship with the target account in physical space.

As illustrated in FIG. 13, first, the activity area estimation unit 120 acquires information of a friend account (S701). Similarly to the first example embodiment, the activity area estimation unit 120 acquires account information of the friend account (related account) being related to the target account from collected social information.

Next, the activity area estimation unit 120 determines whether a user (friend user) of the friend account is an offline friend (S702). Based on the acquired account information of the friend account, the activity area estimation unit 120 determines whether each friend user holding the friend account is a friend in a physical society or is not a friend in the physical society.

The activity area estimation unit 120 calculates, as a determination result of the offline friend, an offline friendship degree representing whether a friend relationship is formed between the friend user and the target user even in the physical space (offline). For example, a score indicating a degree of an offline friend may be calculated for each friend account of the target user, and when the score exceeds a certain threshold value, the offline friendship degree may be set as a value (e.g., “1”) indicating that the friend is an offline friend, and when the score is equal to or less than the threshold value, the offline friendship degree may be set as a value (e.g., “0”) indicating that the friend is not an offline friend.

In addition, the activity area estimation unit 120 may determine whether the friend account of the target user is a local account related to a specific region. For example, the local account is an account of social media being managed for a specific location, region, or the like as a target, among social media accounts. An example of the local account includes an account managed by a community-based company such as a local newspaper, a local government, and a private restaurant. The activity area estimation unit 120 may calculate the offline friendship degree of the friend user, based on a determination result of whether the friend account is the local account.

Further, the activity area estimation unit 120 may calculate the offline friendship degree according to an administrative level of a region targeted by each friend account. For example, the offline friendship degree of an official account of a municipality having a narrow target area may be a high value (e.g., “1”), the offline friendship degree of an account targeted at a prefectural level may be an intermediate value (e.g., “0.7”), and the offline friendship degree of an account targeted at a country level may be a small value (e.g., “0.2”).

In addition, when it is determined that whether the friend account is the local account is unknown, the activity area estimation unit 120 may refer to further friend information of the friend account, and thereby determine whether the friend account is the local account. For example, it may be determined whether the friend account of the target user is the local account, based on whether another friend account of the friend account is the local account.

The activity area estimation unit 120 may calculate reliability of the offline friendship degree (determination result), in addition to the offline friendship degree. The reliability indicates reliability of the determination result with the offline friend. For example, the reliability is determined according to what kind of information or technique is used to determine an offline friend. For example, when it is determined that the friend user of the target user is an offline friend, based on friend information of the friend account of the target account, the reliability of the determination may be regarded as high, and when it is determined that the friend account is an offline friend, based on friend information of another friend of the friend account, the reliability may be regarded as low.

Next, the activity area estimation unit 120 determines a weight to be given to each of the determined friend users (S703). The activity area estimation unit 120 determines a weight indicating a degree of importance of the friend information, based on the calculated offline friendship degree and the reliability. The activity area estimation unit 120 sets the weight of the friend information to a relatively large value for a friend user who is determined to be an offline friend, and sets the weight of the friend information to a relatively small value for a friend user who is determined not to be an offline friend. In addition, in the determination of the weight, increase or decrease of the weight may be adjusted based on the reliability.

Next, the activity area estimation unit 120 calculates a score for an activity candidate position of the target user, based on information of the friend user to which the weight is given (S704). The activity area estimation unit 120 calculates a score representing an activity possibility of the target user at each candidate position, based on weighted friend information. The score indicates possibility that the target user will be active at each candidate position. Herein, the “candidate position” refers to a candidate of a space where the target user is considered to be active. The candidate position may be selected in advance, or the candidate position may be selected from an activity position of the friend user.

For example, the activity area estimation unit 120 calculates a distance between each candidate position and an activity position of each friend user, and calculates a score representing a relationship between presence or absence of a friend relationship and the distance. In the calculation of the score, a degree of importance of the friend information may be adjusted according to the calculated weight of each friend. For example, the larger the value of the weight, the more important the friend information is, and the score is calculated. In other words, the larger the value of the weight, the greater influence of the friend information on the calculation of the score.

Next, the activity area estimation unit 120 estimates an activity range (activity area), based on the calculated score (S705). The activity area estimation unit 120 selects a candidate position, based on a score for each candidate position, and determines any activity range related to the target user. For example, a candidate position having the highest score may be searched. It is considered that the candidate position having the highest score is associated to a location where the target user sets as a base, such as a place of residence or a workplace of the target user. The activity area estimation unit 120 selects the candidate position having the highest score as the activity range of a user. In this case, it is possible to estimate a location where the target user sets as a base.

In addition, the activity area estimation unit 120 may compare the score with a threshold value, and select one or a plurality of candidate positions whose score is equal to or more than the threshold value as the activity range of the user. It is considered that the candidate position whose score is equal to or more than the threshold value is associated to a base such as a place of residence of the target user and a movement range in ordinary life. In this case, it is possible to estimate a location where the target user sets as a base and a moving range in an ordinary range.

As described above, in the present example embodiment, an activity area of a target user is specified, based on an offline friendship degree indicating a degree of a friend relationship, in physical space, between the target user of a target account and a related user (friend user) of a related account being related to the target account. In addition, a score of a candidate position is calculated based on the offline friendship degree of the friend user, and an activity area of the target user is estimated from the calculated score. As a result, it is possible to accurately estimate the activity area of the target user.

Note that, an activity range of the target user may be estimated by using only information of an active user among friend information to be acquired. It is determined whether each of the friend users of the target user is an active user using social media or an inactive user. For example, it may be determined whether the friend user is an active user, based on a posted frequency of the friend account, or it may be determined whether the friend user is an active user, based on information on login of the friend account and the interval.

Note that, the present disclosure is not limited to the above-described example embodiments, and can be appropriately changed without departing from the scope of the present disclosure.

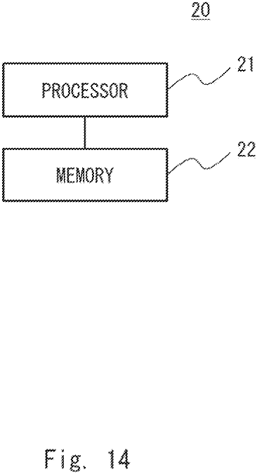

Each configuration according to the above-described example embodiment is configured by hardware or software, or both, and may be configured by one piece of hardware or software, or may be configured by a plurality of pieces of hardware or software. Each device and each function (piece of processing) may be achieved by a computer 20 including a processor 21 such as a central processing unit (CPU) and a memory 22 being a storage device, as illustrated in FIG. 14. For example, a program for performing a method (monitoring assistance method or the like) according to the example embodiment may be stored in the memory 22, and each function may be achieved by executing a program stored in the memory 22 by the processor 21.

These programs can be stored by using various types of non-transitory computer-readable media, and supplied to a computer. The non-transitory computer-readable medium includes various types of tangible storage media. Examples of the non-transitory computer-readable medium include a magnetic recording medium (e.g., a flexible disk, a magnetic tape, and a hard disk drive), a magneto-optical recording medium (e.g., a magneto-optical disk), a CD-read only memory (ROM), a CD-R, a CD-R/W, and a semi-conductor memory (e.g., a mask ROM, a programmable ROM (PROM), an erasable PROM (EPROM), a flash ROM, and a random access memory (RAM)). In addition, the program may also be supplied to the computer by various types of transitory computer-readable media. Examples of the transitory computer-readable medium include an electric signal, an optical signal, and an electromagnetic wave. The transitory computer-readable medium can supply the program to the computer via a wired communication path such as an electric wire and an optical fiber, or a wireless communication path.

Although the present disclosure has been described with reference to the example embodiments, the present disclosure is not limited to the above-described example embodiments. Various changes that can be understood by a person skilled in the art can be made to the configuration and details of the present disclosure within the scope of the present disclosure.

Some or all of the above-described example embodiments may be described as the following supplementary notes, but are not limited thereto.

### Supplementary Note 1

An assistance device including:
a personal information extraction means for extracting personal information being capable of discriminating a target user holding a target account, based on account information to be acquired from the target account in cyberspace;
a position information extraction means for extracting position information related to the target user, based on the account information; and
an output means for outputting the extracted personal information and the extracted position information as assistance information for assisting crime prevention around the position information in physical space.

### Supplementary Note 2

The assistance device according to Supplementary note 1, wherein the assistance information is information for assisting monitoring or investigation of the target user.

### Supplementary Note 3

The assistance device according to Supplementary note 1 or 2, wherein the account information includes account information of the target account or account information of a related account being related to the target account.

### Supplementary Note 4

The assistance device according to Supplementary note 3, wherein the related account is an account having a connection with the target account in the cyberspace.

### Supplementary Note 5

The assistance device according to Supplementary note 3 or 4, wherein the related account includes an alternative account different from the target account being held by the target user.

### Supplementary Note 6

The assistance device according to Supplementary note 5, further including an account specification means for specifying the alternative account, based on account information of the target account and account information of the related account.

### Supplementary Note 7

The assistance device according to Supplementary note 6, wherein the account specification means specifies the alternative account, based on position information acquired from account information of the related account.

### Supplementary Note 8

The assistance device according to Supplementary note 7, wherein the account specification means specifies hierarchical position information acquired by hierarchizing the acquired position information according to a granularity level of a position, and specifies the alternative account, based on the specified hierarchical position information.

### Supplementary Note 9

The assistance device according to Supplementary note 6, wherein the account specification means specifies the alternative account, based on content data acquired from account information of the related account.

### Supplementary Note 10

The assistance device according to any one of Supplementary notes 3 to 9, wherein the personal information extraction means and the position information extraction means extract the personal information and the position information, based on account information of any one of the target account and the related account.

### Supplementary Note 11

The assistance device according to Supplementary note 10, wherein the personal information extraction means and the position information extraction means extract the personal information and the position information, based on account information of an account having high reliability among the target account and the related account.

### Supplementary Note 12

The assistance device according to Supplementary note 11, wherein the reliability is based on person attribute information acquired from account information of the target account and the related account.

### Supplementary Note 13

The assistance device according to any one of Supplementary notes 1 to 12, wherein the account information includes profile information or posted information.

### Supplementary Note 14

The assistance device according to any one of Supplementary notes 1 to 13, wherein the personal information includes any one of biological information, soft biometric information, belongings, a name, and attribute information of the target user.

### Supplementary Note 15

The assistance device according to any one of Supplementary notes 1 to 14, wherein the position information extraction means specifies the position information, based on projection of an acquired image to be acquired from the account information.

### Supplementary Note 16

The assistance device according to Supplementary note 15, wherein the position information extraction means specifies the position information, based on collation between the acquired image and a plurality of position images to which position information is associated in advance.

### Supplementary Note 17

The assistance device according to Supplementary note 16, wherein the position information extraction means collates a position image related to the target account among the plurality of position images with the acquired image.

### Supplementary Note 18

The assistance device according to Supplementary note 16 or 17, wherein the acquired image is a ground view image captured in a ground view, and the plurality of position images are a plurality of bird’s-eye view images captured in a bird’s-eye view.

### Supplementary Note 19

The assistance device according to Supplementary note 18, wherein the position information extraction means specifies the bird’s-eye view image coinciding with the acquired image by a discriminator performing machine learning on a relationship between the ground view image and the plurality of bird’s-eye view images.

### Supplementary Note 20

The assistance device according to Supplementary note 19, wherein the discriminator includes:
a first extraction means for extracting a feature of the ground view image;
a second extraction means for extracting a feature of the bird’s-eye view image; and
a determination means for determining whether the ground view image and the bird’s-eye view image coincide with each other, based on the extracted feature of the ground view image and the extracted feature of the bird’s-eye view image.

### Supplementary Note 21

The assistance device according to any one of Supplementary notes 1 to 20, wherein the position information extraction means estimates an activity area of the target user as the position information to be extracted.

### Supplementary Note 22

The assistance device according to Supplementary note 21, wherein the position information extraction means estimates the activity area, based on a location specified from account information of the target account and a related account being related to the target account.

### Supplementary Note 23

The assistance device according to Supplementary note 21 or 22, wherein the position information extraction means estimates the activity area according to whether a location specified from the account information is an ordinary or non-ordinary activity location of the target user.

### Supplementary Note 24

The assistance device according to Supplementary note 22, wherein the position information extraction means estimates the activity area, based on account information of the related account having a friend relationship with the target account in physical space.

### Supplementary Note 25

A system including:
a plurality of monitoring systems configured to monitor different locations; and
an assistance device, wherein the assistance device includes:
   a personal information extraction means for extracting personal information being capable of discriminating a target user holding a target account, based on account information to be acquired from the target account in cyberspace;
   a position information extraction means for extracting position information related to the target user, based on the account information; and
   an output means for outputting the extracted personal information to the monitoring system to be selected based on the extracted position information.

### Supplementary Note 26

The system according to Supplementary note 25, wherein the monitoring system registers the output personal information in a watchlist being a list of objects to be monitored.

### Supplementary Note 27

The system according to Supplementary note 25 or 26, wherein the output means selects the monitoring system in a public facility around the position information.

### Supplementary Note 28

The system according to any one of Supplementary notes 25 to 27, wherein the output means selects the monitoring system, based on a score indicating possibility that the target user is located.

### Supplementary Note 29

The system according to any one of Supplementary notes 25 to 28, wherein the output means selects the monitoring system, based on a congestion degree around the position information.

### Supplementary Note 30

The system according to any one of Supplementary notes 25 to 29, wherein the output means selects the monitoring system in public transportation of a moving route of the target user being estimated from the position information.

### Supplementary Note 31

An assistance method including:
extracting personal information being capable of discriminating a target user holding a target account, based on account information to be acquired from the target account in cyberspace;
extracting position information related to the target user, based on the account information; and
outputting the extracted personal information and the extracted position information as assistance information for assisting crime prevention around the position information in physical space.

### Supplementary Note 32

A non-transitory computer-readable medium storing an assistance program for causing a computer to execute processing of:
extracting personal information being capable of discriminating a target user holding a target account, based on account information to be acquired from the target account in cyberspace;
extracting position information related to the target user, based on the account information; and
outputting the extracted personal information and the extracted position information as assistance information for assisting crime prevention around the position information in physical space.

### REFERENCE SIGNS LIST

| | |
|---|---|
| 1 | CYBER-PHYSICAL INTEGRATED MONITORING SYSTEM |
| 10 | ASSISTANCE DEVICE |
| 11 | PERSONAL INFORMATION EXTRACTION UNIT |
| 12 | POSITION INFORMATION EXTRACTION UNIT |
| 13 | OUTPUT UNIT |
| 20 | COMPUTER |
| 21 | PROCESSOR |
| 22 | MEMORY |
| 100 | MONITORING ASSISTANCE DEVICE |
| 101 | SOCIAL MEDIA INFORMATION ACQUISITION UNIT |

| | |
|---|---|
| 102 | ACCOUNT SPECIFICATION UNIT |
| 103 | ACCOUNT INFORMATION EXTRACTION UNIT |
| 104 | PERSONAL INFORMATION EXTRACTION UNIT |
| 105 | POSITION INFORMATION EXTRACTION UNIT |
| 106 | MONITORING SYSTEM SELECTION UNIT |
| 107 | PERSONAL INFORMATION OUTPUT UNIT |
| 108 | STORAGE UNIT |
| 110 | IMAGE POSITION SPECIFICATION UNIT |
| 111 | SEARCH UNIT |
| 112 | DISCRIMINATOR |
| 113 | POSITION DATABASE |
| 114 | EXTRACTION NETWORK |
| 115 | EXTRACTION NETWORK |
| 116 | DETERMINATION NETWORK |
| 120 | ACTIVITY AREA ESTIMATION UNIT |
| 200 | MONITORING SYSTEM |
| 201 | MONITORING DEVICE |
| 202 | MONITORED PERSON INFORMATION EXTRACTION UNIT |
| 203 | MONITORED PERSON INFORMATION COLLATION UNIT |
| 204 | COLLATION RESULT OUTPUT UNIT |
| 205 | WATCHLIST STORAGE UNIT |
| 206 | WATCHLIST GENERATION UNIT |
| 300 | SOCIAL MEDIA SYSTEM |

What is claimed is:

1] An assistance device comprising:
at least one memory storing instructions, and
at least one processor configured to execute the instructions stored in the at least one memory to;
extract personal information being capable of discriminating a target user holding a target account, based on account information to be acquired from the target account in cyberspace;
extract position information related to the target user, based on the account information; and
output the extracted personal information and the extracted position information as assistance information for assisting crime prevention around the position information in physical space.

2] The assistance device according to claim 1, wherein the assistance information is information for assisting monitoring or investigation of the target user.

3] The assistance device according to claim 1, wherein the account information includes account information of the target account or account information of a related account being related to the target account.

4] The assistance device according to claim 3, wherein the related account is an account having a connection with the target account in the cyberspace.

5] The assistance device according to claim 3, wherein the related account includes an alternative account different from the target account being held by the target user.

6] The assistance device according to claim 5, wherein the at least one processor is further configured to execute the instructions stored in the at least one memory to specify the alternative account, based on account information of the target account and account information of the related account.

7] The assistance device according to claim 6, wherein the at least one processor is further configured to execute the instructions stored in the at least one memory to specify the alternative account, based on position information acquired from account information of the related account.

8] The assistance device according to claim 7, wherein the at least one processor is further configured to execute the instructions stored in the at least one memory to specify hierarchical position information acquired by hierarchizing the acquired position information according to a granularity level of a position, and specify the alternative account, based on the specified hierarchical position information.

9] The assistance device according to claim 6, wherein the at least one processor is further configured to execute the instructions stored in the at least one memory to specify the alternative account, based on content data acquired from account information of the related account.

10] The assistance device according to claim 3, wherein the at least one processor is further configured to execute the instructions stored in the at least one memory to extract the personal information and the position information, based on account information of any one of the target account and the related account.

11] The assistance device according to claim 10, wherein the at least one processor is further configured to execute the instructions stored in the at least one memory to extract the personal information and the position information, based on account information of an account having high reliability among the target account and the related account.

12] The assistance device according to claim 11, wherein the reliability is based on person attribute information acquired from account information of the target account and the related account.

13] The assistance device according to claim 1, wherein the account information includes profile information or posted information.

14] The assistance device according to claim 1, wherein the personal information includes any one of biological information, soft biometric information, belongings, a name, and attribute information of the target user.

15] The assistance device according to claim 1, wherein the at least one processor is further configured to execute the instructions stored in the at least one memory to specify the position information, based on projection of an acquired image to be acquired from the account information.

16] The assistance device according to claim 15, wherein the at least one processor is further configured to execute the instructions stored in the at least one memory to specify the position information, based on collation between the acquired image and a plurality of position images to which position information is associated in advance.

17] The assistance device according to claim 16, wherein the at least one processor is further configured to execute the instructions stored in the at least one memory to collate a position image related to the target account among the plurality of position images with the acquired image.

18] The assistance device according to claim 16, wherein the acquired image is a ground view image captured in a ground view, and the plurality of position images are a plurality of bird’s-eye view images captured in a bird’s-eye view.

19-30. (canceled)

31] An assistance method comprising:
extracting personal information being capable of discriminating a target user holding a target account, based on account information to be acquired from the target account in cyberspace;
extracting position information related to the target user, based on the account information; and
outputting the extracted personal information and the extracted position information as assistance information for assisting crime prevention around the position information in physical space.

32] A non-transitory computer-readable medium storing an assistance program for causing a computer to execute processing of:
extracting personal information being capable of discriminating a target user holding a target account, based on account information to be acquired from the target account in cyberspace;
extracting position information related to the target user, based on the account information; and
outputting the extracted personal information and the extracted position information as assistance information for assisting crime prevention around the position information in physical space.
